(19) United States
(12) Patent Application Publication
(10) Pub. No.: US 2006/0198023 A1
(43) Pub. Date: Sep. 7, 2006

(54) SALIENT REFLECTOR FOR USE ON ROAD

(76) Inventor: Hungchen LEE, Taipei (TW)

Correspondence Address: BANGER SHIA, 204 CANYON CREEK, VICTORIA, TX, 77901-3695, US

(21) Appl. No.: 11/307,940

(22) Filed: Feb. 28, 2006

(30) Foreign Application Priority Data
Mar. 4, 2005 (CN) 200520055405.1

(51) Int. Cl. G02B 5/12

(52) U.S. Cl. 359/515; 359/551

(57) ABSTRACT

The present invention provides a salient reflector for use on road including a plate with a prismatic specular surface on full inner surface, and a backup plate attaching on all the inner surface, wherein, coordinating to the inner prismatic specular surface of the plate, a counter prismatic surface is formed on the contacting surface of the backup plate for matching said prismatic specular surface exactly. The present invention can bring the reflecting effect of the original design into action fully, and avoids breaking down, and really improves the shock resistance of the goods.

### BACKGROUND OF THE INVENTION

1. Field of the Invention

The present invention relates to a salient reflector for use on road, and more particularly to a salient reflector laid on road with high shock resistance and crush resistance.

2. Description of Prior Art

In accordance with a conventional salient reflector for use on road, as shown in FIG. 1, it is just only a plate 1 with prismatic specular surface 11 at inside surface, and there is not any rib reinforcement on it. As laying on road, the inside surface of the plate 1 is processed in electroplating treatment so as to attach a safety film 2 (as shown in FIG. 2) on the prismatic specular surface 11 firstly, then stuff some filler 5 (epoxy resin and silica sand composition) at inside so that it can be fastened on road as a salient reflector.

Due to no any rib reinforcement formed on the plate 1 of the conventional salient reflector, as it is fastened saliently on road, bearing on rolling of vehicles in a certain long term, the reflector is easy to be broken down, and due to no support coming from the rib reinforcement, once a corner of the plate 1 is broken off, the whole plate 1 will be completely crushed in passing, so as to lose alarming reflecting function on road any more. Additionally, because the filler 5 is stuffed into the inside of the plate 1 directly, for preventing the filler 5 from directly contacting with the prismatic specular surface 11 so as to affect the reflecting effect, the electroplated safety film 2 has to be pre-set on the inside surface of the plate 1 before stuffing filler 5, but the electroplating process may affect the reflecting effect greatly of the reflector so that the original designed reflecting effect can not be brought into action fully, actually the salient reflector just gets to 50% reflecting effect of the original design, so the reflecting function is obviously reduced.

Later, for bring the reflecting effect designed in original design into play fully, meanwhile preventing the plate 1 from breaking down, the inventor developed a new salient reflector used on road, as shown in FIG. 3 to FIG. 5, in which a flat backup plate 4 is attached on the prismatic specular surface 11 side of the plate 1 by welding or gluing and so on, and a rib reinforcement 12 is formed on the prismatic specular surface 11 side on the extension of the prism between said prismatic specular surface 11 and the backup plate 4, and the shape of the rib reinforcement 12 is in wave as prefer embodiment, as shown in FIG. 3, the rib reinforcement 12 is molded on the prismatic specular surface 11 directly; said rib reinforcement can be molded on the top surface of the backup plate 4 directly, as shown in FIG. 4; said rib reinforcement can be split by tow parts 12′ and 14′ molded on the both opposite sided of the plate 1 and the backup plate 4 separately, as shown in FIG. 5.

As laying on road, the above-mentioned salient reflector can efficiently prevent the filler 5 from contacting with the prismatic specular surface 11 directly, so that the electroplating surface of the prismatic specular surface 11 is not affected by the filler 5, therefore the reflecting effect designed in the original design can be brought into action fully, the reflection function is improved evidently; meanwhile by the rib reinforcement 12 41 or said integrated rib reinforcement 12′ 41′, the intensity of the whole plate 1 is not only increased for bearing extra force shocking and crushing, but also the reflection effect may not be affected.

Although adding a backup plate improves the performance, but above-mentioned salient reflector using on road still not gets to desired level of shock resistance, the sake is there is bigger gap exists between the plate 1 and the backup plate 4, and they are made of different materials—the plate 1 is made of PMMA (polymethyl methacrylate), and the backup plate 4 is made of plastic, and the elasticity of them is so poor that the plate 1 is easy to be broken down under over-tortuous when extra force exactly exerts on the non-rib spot.

### OBJECTS AND SUMMARY OF THE INVENTION

It is therefore a main object of the present invention to provide a salient reflector for use on road that can bring reflection effect designed in the original design into action fully, and efficiently prevent it from breaking down with high shock resistance.

For archiving the goal, the present invention provides a salient reflector for use on road including a plate with prismatic specular surface formed on the inner surface fully, and a backup plate attached on the full inner surface, wherein said backup plate possesses a counter prismatic specular surface molded on the contacting surface to the prismatic specular surface of the plate so that they can jog together in table contact fully.

Due to applying above-mentioned structure, the present invention adds a backup plate on the whole inner surface to prevent the filler from contacting with the prismatic specular surface, so efficiently bring the reflecting effect of original design into action fully; additionally, the counter prismatic surface formed on the top side of the backup plate exactly coordinating to the inner surface of the plate so that each coordinated prisms engage up together exactly to eliminate the gap between them further to improve the support, as laying on road, the salient plate is exerted with an extra force and deformed a bit due to the full area support coming from the backup plate to avoid over-deforming and damaging happened, the shock resistance of the plate is improved actually.

### BRIEF DESCRIPTION OF THE DRAWINGS

FIG. 1 is a scheme of the first prior art.

FIG. 2 is a sectional view of the first prior art.

FIG. 3 is an exploded solid view of the second prior art.

FIG. 4 is an exploded solid view of the third prior art.

FIG. 5 is an exploded solid view of the fourth prior art.

FIG. 6 is an exploded solid view of the present invention.

FIG. 7 is a sectional view of FIG. 6.

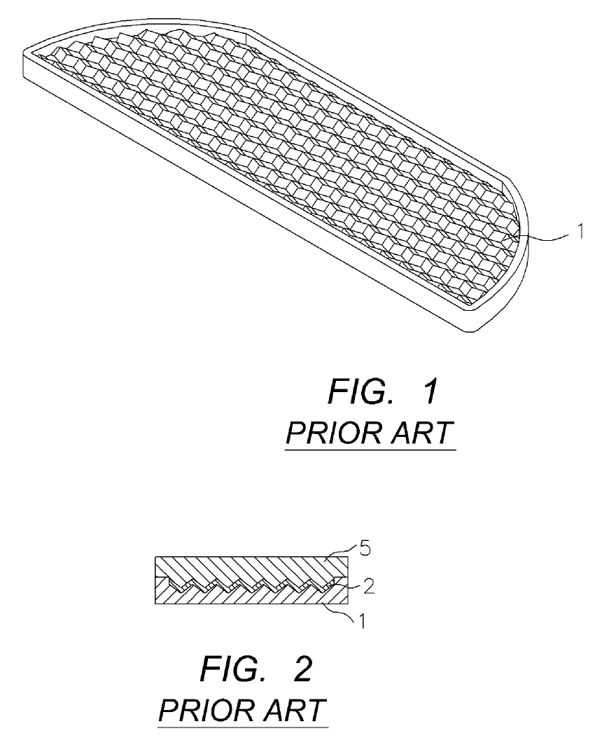

### DETAILED DRESCRIPTION OF PREFERRED EMBODIMENTS

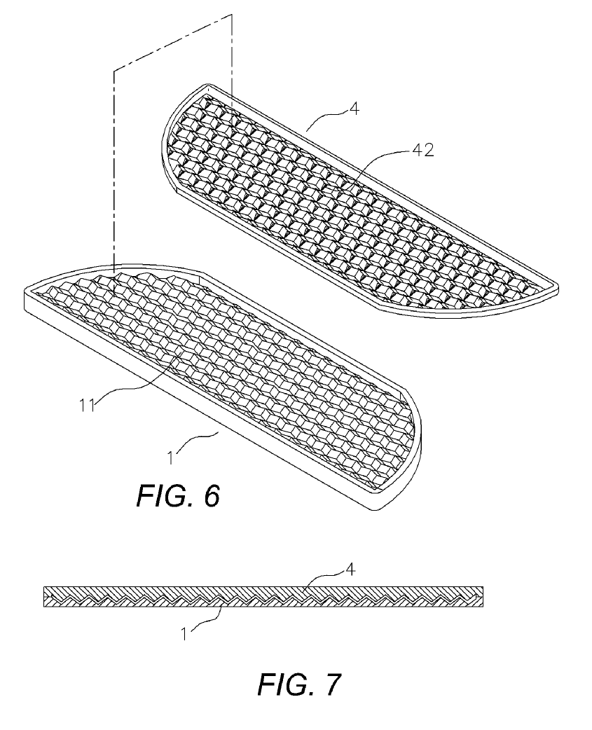

Referring to FIG. 6 to FIG. 7, a salient reflector for use on road provided of the present invention is typically consisted of a plate 1 with a prismatic specular surface 11 on full inner surface, and a backup plate 4 attaching on all the inner surface, wherein, coordinating to the inner prismatic specular surface 11 of the plate 1, a counter prismatic surface 42 is formed on the contacting surface of the backup plate 4 for matching said prismatic specular surface 11 exactly.

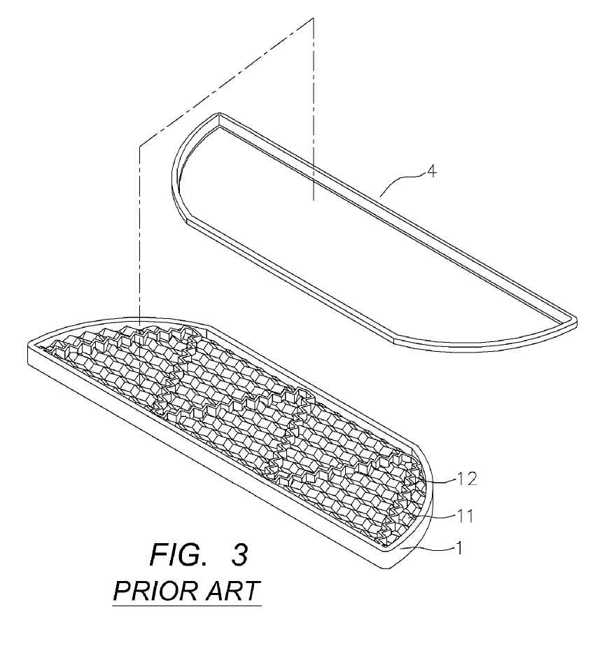

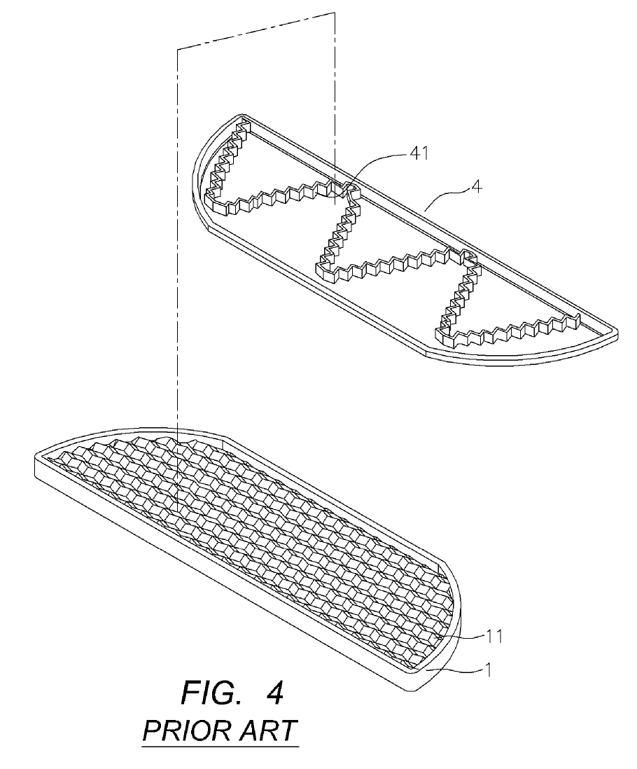

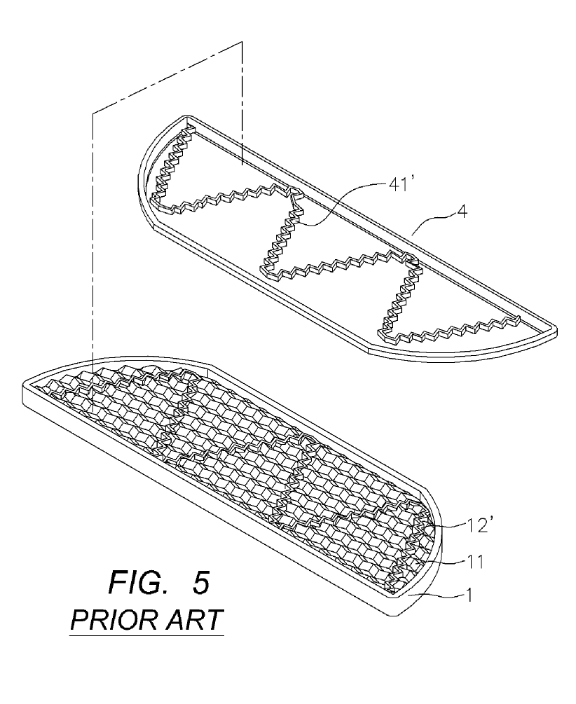

So, by means of the added backup plate 4, the present invention can efficiently prevent the filler 5 from contacting with the prismatic specular surface 11 directly, so as to bring the reflecting effect of the original design into action fully, and the gap between the plate 1 and the backup plate 4 is much smaller than the second to the fourth prior arts (as shown in FIG. 3 and FIG. 5), therefore, as the salient reflector laid on road is exerted under an extra force, the integrated plate 14 is just deformed a bit, due to the full support coming from the full area contacting between the counter prism surface 42 of the backup plate 4 and the prismatic specular surface 11 of the plate 1, the backup supporting coming from the all backup plate 4 via the full contacting efficiently prevents the plate mentioned 1 from over-deforming, and avoids breaking down, and really improves the shock resistance of the goods.

What is claimed is:

1. A salient reflector for use on road typically consisted of a plate with a prismatic specular surface on full inner surface, and a backup plate attaching on all the inner surface, wherein, coordinating to the inner prismatic specular surface of the plate, a counter prismatic surface is formed on the contacting surface of the backup plate for matching said prismatic specular surface exactly.
